(19) United States
(12) Patent Application Publication
(10) Pub. No.: US 2022/0198782 A1
(43) Pub. Date: Jun. 23, 2022

(54) EDGE DEVICE HAVING A HETEROGENOUS NEUROMORPHIC COMPUTING ARCHITECTURE

(71) Applicant: SRI International, Menlo Park, CA (US)

(72) Inventors: David Chao ZHANG, Belle Mead, NJ (US); Michael R. PIACENTINO, Robbinsville, NJ (US); Aswin NADAMUNI RAGHAVAN, Pennington, NJ (US)

(21) Appl. No.: 17/553,239

(22) Filed: Dec. 16, 2021

Related U.S. Application Data
(60) Provisional application No. 63/126,972, filed on Dec. 17, 2020.

(51) Int. Cl. G06V 10/774; G06N 3/04; G06N 3/08

(52) U.S. Cl. CPC G06V 10/774; G06N 3/082; G06N 3/0454

(57) ABSTRACT

An edge device comprising a feature extractor and a reconfigurator. The feature extractor comprises a first neural network for encoding input information into data vectors and extracting particular data vectors representing features within the input information, wherein the first neural network comprises at least one encoder layer and at least one adaptor layer. The reconfigurator is coupled to the feature extractor and comprises a second neural network for classifying the particular data vectors and wherein, upon requiring additional features to be extracted, the reconfigurator adapts at least one layer in the first neural network, second neural network or both by performing at least one of: (1) altering weights, (2) adding layers, (3) deleting layers, (4) reordering layers to improve classification of particular data vector. The first neural network, the second neural network or both are trained using gradient-free training.

### RELATED APPLICATION

This application claims benefit to U.S. Provisional Patent Application Ser. No. 63/126,972, filed 17 Dec. 2020 and entitled “System And Method For A Non-Conventional Neuromorphic Computing Architecture For AI On The Edge,” which is hereby incorporated herein in its entirety by reference.

### FIELD

Embodiments of the present principles generally relate to computer network edge devices and, more particularly, to an edge device having a heterogeneous neuromorphic computing architecture.

### BACKGROUND

Computing that uses artificial intelligence (AI) and/or machine learning is becoming ubiquitous. However, such computing systems are centralized and, in many instances, the computing capabilities are provided to users as a service. Because AI computing is available as a service from a centralized server, computer network edge devices, such as mobile phones, tablets, digital assistants, personal computers, internet-of-things (IoT) devices, and the like, must communicate with the centralized server to utilize AI computing. Such remote processing results in delays in data transfer as well as requires limitations on the type of processing and the usefulness of the results.

Thus, there is a need for a network edge device having a heterogeneous neuromorphic computing architecture to facilitate local use of artificial intelligence computing within the edge device.

### SUMMARY

Embodiments of the present invention generally relate to an edge device that comprises a heterogeneous neuromorphic computing architecture to facilitate local use of artificial intelligence computing within the edge device as shown in and/or described in connection with at least one of the figures.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

So that the manner in which the above recited features of the present principles can be understood in detail, a more particular description of the principles, briefly summarized above, may be had by reference to embodiments, some of which are illustrated in the appended drawings. It is to be noted, however, that the appended drawings illustrate only typical embodiments in accordance with the present principles and are therefore not to be considered limiting of its scope, for the principles may admit to other equally effective embodiments.

FIG. 1 depicts a high-level block diagram of an edge device network in accordance with at least one embodiment of the invention;

FIG. 2 depicts a high-level flow diagram representing operation of an edge device of FIG. 1 in accordance with at least one embodiment of the invention;

FIG. 3 depicts a block diagram of the first neural network of a feature extractor in accordance with at least one embodiment of the invention;

FIG. 4 depicts a block diagram of an exemplary hardware arrangement of the edge device of FIG. 1 in accordance with at least one embodiment of the invention;

FIG. 5 depicts a flow diagram of an exemplary training process for an edge device in accordance with at least one embodiment of the invention; and

FIG. 6 depicts a flow diagram of an exemplary operation process for an edge device in accordance with at least one embodiment of the invention.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Embodiments of the present principles generally relate to methods, apparatuses and systems for creating and operating an edge device having a heterogeneous neuromorphic computing architecture. While the concepts of the present principles are susceptible to various modifications and alternative forms, specific embodiments thereof are shown by way of example in the drawings and are described in detail below. It should be understood that there is no intent to limit the concepts of the present principles to the particular forms disclosed. On the contrary, the intent is to cover all modifications, equivalents, and alternatives consistent with the present principles and the appended claims.

Embodiments of an edge device having a heterogeneous neuromorphic computing architecture described herein enable many of capabilities and applications not previously achievable thru any individual computing system. Embodiments of the disclosed architecture address the problem of decreasing size weight and power (SWaP) for edge devices as well as enable edge devices to locally perform artificial intelligence (AI) processing within the edge device. As such, edge devices will no longer be required to rely upon centralized AI processing. In addition, embodiments of the invention facilitate federated learning amongst edge devices.

More specifically, the heterogeneous neuromorphic computing architecture of the edge device comprises a feature extractor and a classifier. The feature extractor comprises a feature encoder and a feature adaptor. The classifier is capable of feeding information back to the feature adaptor to adapt the feature extractor to the needs of the classifier. As such, the classifier is capable of reconfiguring the architecture and is therefore referred to herein as a reconfigurator.

The feature extractor comprises a first neural network having a plurality of layers, where each layer's function is defined by weights. Some layers form a feature encoder and weights in the feature encoder layers, once trained, are fixed (i.e., not adaptable). Other layers in the first neural network form a feature adaptor and weights in the feature adaptor layers are adaptable (i.e., changeable via control from the reconfigurator). The feature extractor encodes the incoming data and extracts features from the data that are classified by the reconfigurator. The reconfigurator comprises a second neural network of examplars to classify (i.e., identify) specific elements, for example, objects within digital imagery, within the input data.

The edge device is initially trained in its native local environment, or a “parent” edge device is trained, and the feature extractor weights and reconfigurator exemplars are transferred (pushed) to other edge devices in the field. After initial training is complete, the feature encoder encodes input data (e.g., digital imagery, digitized sounds, digitized sensor reading, etc.) to enable features in the data to be extracted. In one embodiment, the first neural network encodes the input data into hyperdimensional (HD) vectors. Simultaneously, the feature adaptor applies neural network weights to identify and extract specific features from the encoded data (e.g., extract specific HD vectors representing specific features). The extracted features are processed by the reconfigurator (i.e., a classifier that may control the feature adaptor, as needed) using exemplars within the second neural network. Both the feature adaptor neural network and the reconfigurator neural network are trained using gradient-free training. During processing, adaptor weights and/or exemplars may be updated by the reconfigurator to improve processing. Furthermore, a given edge device may share information, such as descriptors (i.e., a plurality of weights and biases defining a feature to be extracted), weights and exemplars, with other edge devices to improve processing as well as facilitate edge device retraining to adapt to environmental and data input variations.

The aforementioned embodiments and features are now described below in detail with respect to the Figures.

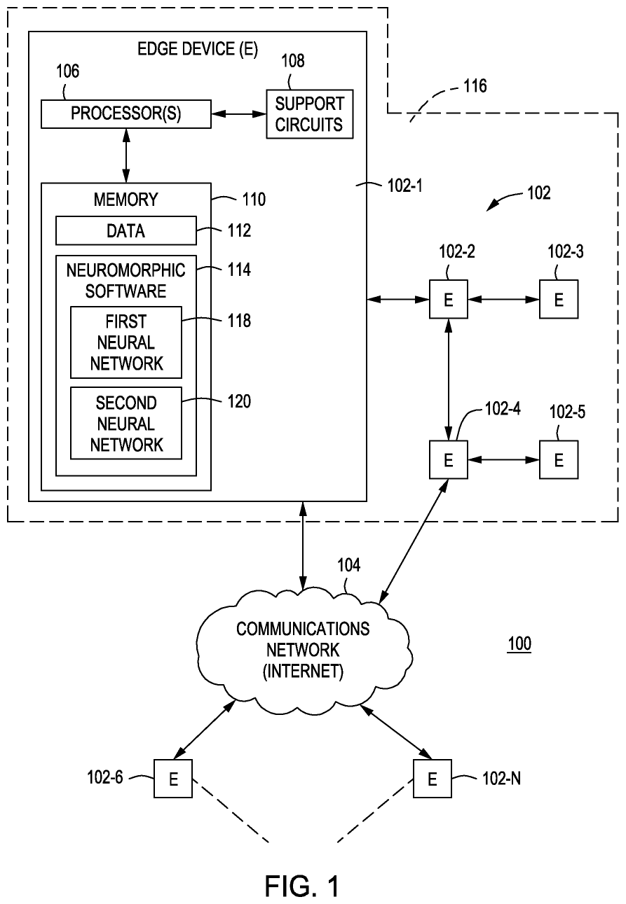

FIG. 1 depicts a high-level block diagram of an edge device network 100 in accordance with at least one embodiment of the invention. The network 100 comprises at least one edge device 102-1 communicatively coupled to a communications network 104 (e.g., Internet). In the depicted embodiment, a plurality of edge devices 102-1, 102-2, 102-3 . . . 102-N (collectively edge devices 102 form edge device network 100) are shown. The edge devices 102 may be directly connected to one another to form a subnetwork 116 or they may be connected to one another through the communications network 104.

The edge devices 102 may be any form of computing device capable of processing data using a heterogeneous neuromorphic computing architecture as described herein. Examples of such computing devices include, but are not limited to, mobile phones, tablets, laptop computers, personal computers, digital assistants, drones, tactical communications and/or computing devices, autonomous vehicles, autonomous robots, and the like. Each edge device (e.g., device 102) generally comprises at least one processor 106, support circuits 108 and memory 110.

In various embodiments, the edge devices 102 may be a uniprocessor system including one processor 108, or a multiprocessor system including several processors 108 (e.g., two, four, eight, or another suitable number). Processors 108 may be any suitable processor capable of executing instructions. For example, in various embodiments, processors 108 may be general-purpose or embedded processors implementing any of a variety of instruction set architectures (ISAs). In multiprocessor systems, each of processors 108 may commonly, but not necessarily, implement the same ISA. Examples of processors 108 include, but are not limited to, central processing unit(s) (CPUs), graphic processing units (GPUs), process in memory (PIM) units, application specific integrated circuits (ASICs), field programmable gate arrays (FPGAs), as well as combinations thereof.

Memory 110 comprises at least one non-transitory computer readable media that may be configured to store program instructions (neuromorphic software 114 and related neural networks (e.g., first neural network 118 and second neural network 120) and/or data 112 accessible by processor 108. In some embodiments, as further described below, the first and second neural networks 118 and 120 may each be formed of functional layers residing in a single neural network. In various embodiments, system memory 114 may be implemented using any suitable memory technology, such as static random-access memory (SRAM), synchronous dynamic RAM (SDRAM), nonvolatile/Flash-type memory, or any other type of memory. The processor 108 and memory 110 may also be integrated into a PIM unit to facilitate high speed data processing and data transfer. In the illustrated embodiment, program instructions and data implementing any of the elements of the embodiments described herein may be stored within memory 110. In other embodiments, program instructions and/or data may be received, sent or stored upon different types of computer-accessible media or on similar media separate from memory 110 or edge device 102 (i.e., remote storage).

The support circuits 108 may comprise well-known circuits and devices that support the functionality of the processor 108. The support circuits comprise, but are not limited to, cache, clock circuits, power supplies, network interface circuits, I/O interface circuits, keyboard, touchpad, sensors, display circuits, cameras, and the like. The network interface may be configured to allow data to be exchanged between the edge devices 102 and/or to a network (e.g., network 104). In various embodiments, network 104 may include one or more networks including, but not limited to, Local Area Networks (LANs) (e.g., an Ethernet or corporate network), Wide Area Networks (WANs) (e.g., the Internet), wireless data networks, some other electronic data network, or some combination thereof. In various embodiments, the support circuits 108 may support communication via wired or wireless general data networks, such as any suitable type of Ethernet network, for example; via digital fiber communications networks; via storage area networks such as Fiber Channel SANs, or via any other suitable type of network and/or protocol. The edge devices 102 may communicate based on various computer communication protocols such a Wi-Fi, Bluetooth (and/or other standards for exchanging data over short distances includes protocols using short-wavelength radio transmissions), USB, Ethernet, cellular, an ultrasonic local area communication protocol, etc.

As is described in detail below, each edge device 102 may be trained for processing input data using artificial intelligence (e.g., neuromorphic processing through execution of software 114). Post training, the edge devices continue to learn and improve their processing capabilities. Additionally, the edge devices 102 may share descriptors, weights, exemplars and/or other information to improve the processing performed by other edge devices within the edge device network 100 or within a particular subnetwork 116. Furthermore, an individual edge device may be trained, then the parameters (e.g., weights, biases, descriptors and exemplars) of the trained neural network may be pushed, or otherwise sent, to other edge devices. For example, an edge device may be trained to identify a particular object captured by a sensor (e.g., camera). The parameters of the trained neural network may be sent to other edge devices such that those devices can identify the particular object. Subsequent to receiving the trained neural network parameters, the edge devices 102 continue to learn and improve their performance to identify the object within the local environment.

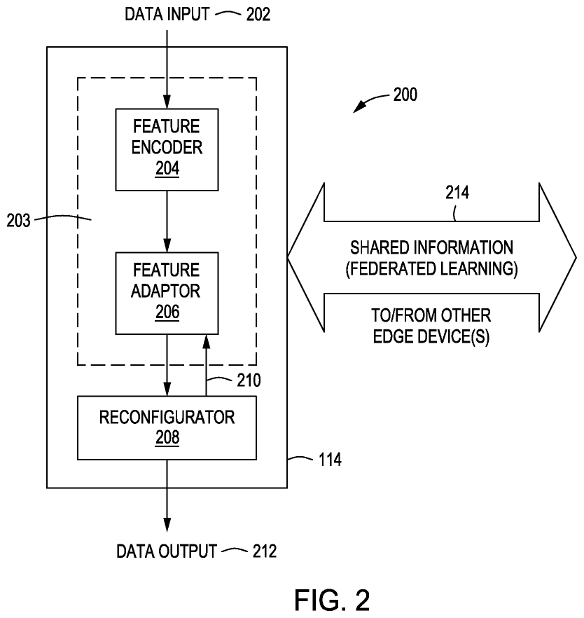

FIG. 2 depicts a high-level flow diagram representing operation of an edge device 102 of FIG. 1 in accordance with at least one embodiment of the invention. When instructions within neuromorphic software 114 are executed, a method 200 is performed to process data to generate an output response. The method 200 performs biological computing using at least one neural network. One example of biological computing that forms at least one embodiment is hyperdimensional (HD) computing, where data is encoded and processed as high-dimensioned vectors. In one embodiment, the vector may be a binary vector or, in other embodiments, the vector may be a non-binary vector. HD computing is very resilient to random noise as well as provides for very fast processing because of its fully binary nature. In addition, forming exemplars from HD vectors may be performed without gradient back propagation, e.g., gradient-free training.

The method 200 comprises two subprocesses, namely, a feature extractor 203 and a reconfigurator 208 (i.e., a classifier that is capable of reconfiguring the operation of the feature extractor 203). The feature extractor 203 comprises a feature encoder 204 and a feature adaptor 206. The method 200 receives a data input at 202 and produces a data output at 212. For example, the data input may be a sequence of images from a sensor (e.g., camera). The method 200 may process the image sequence to identify certain objects within the imagery, e.g., recognize an automobile or person. Once identified, the data output indicates that the object has been identified and may supply information about the object (e.g., direction of travel, confidence level of the identification, etc.). In other applications, the sensor may be a microphone and the edge device used for speech recognition. In another application, the input data may be a scan of written material and the method may perform written language classification/recognition. The applications of edge devices having a neuromorphic computing architecture are endless and, generally, may be applied wherever data is available that requires classification of information within the data.

As shall be described in detail below, the feature extractor 203 comprises a first neural network (118 in FIG. 1) that extracts features from within the input data. The extracted features are classified by a second neural network (120 in FIG. 1) in the reconfigurator 208. If the reconfigurator 208 requires different or updated features to be extracted to improve the classification function, the reconfigurator 208 couples information along path 210 back to the feature extractor 203 to adapt feature parameters of the first neural network to extract the different or updated features (e.g., adjust weights in adaptable layers of the first neural network). In this manner, the feature extractor 203 includes within the first neural network, the ability to encode features (feature encoder 204) and adapt features (feature adaptor 206) to be extracted.

In one exemplary embodiment, the feature encoder 204 encodes the raw data into a format that is compatible with the processor of the edge device. As an example of one type of encoding that may be utilized, the feature encoder 204 uses hyperdimensional (HD) encoding to encode the data into high-dimensioned vectors (i.e., hypervectors). The input data is initially a training data set that is encoded and processed by the extractor 206 and reconfigurator 208 to establish a weights, descriptors and examplars for performing feature extraction and classification. Once trained, the data input may be sensor data that is processed by the trained neural networks to determine the content of the sensor data, i.e., identify objects in the data.

The feature encoder 204 uses modular and compact descriptor-based classifiers. Each classifier is a few 100 to 1000 bytes/class. With such a small size, the classifiers are easy to exchange and share as well as being scalable and incremental in memory. In one embodiment, the output of the feature extractor 203 is an HD vector representing at least one feature contained in the input data.

In one exemplary embodiment, the feature extractor 203 processes the data to extract features from the data. The encoder 204 may be pre-trained through establishment of weights within a neural network that represent various classes of objects, e.g., certain sounds, images, written characters, etc. For example, if the edge device is enabled to recognize automobile types, the feature extractor 203 would be trained to identify a vehicle within the data and extract the feature of a vehicle represented by an HD vector.

In one exemplary embodiment, the reconfigurator 208 is coupled to the feature extractor 203 and processes the extracted features to classify the feature, e.g., identify vehicle features as car, sedan, truck, etc. The reconfigurator 208 utilizes exemplars of hypervectors within the second neural network to match against the incoming extracted features (e.g., an exemplar is an HD vector that is compared to the HD vector representing a feature). Matches are identified and a confidence level (e.g., hamming distance) is created for each match. The reconfigurator 208 adjusts the exemplars (e.g., alters weights, adds layers, deletes layers, reorders layers, etc. to update the second neural network) to improve its matching abilities, i.e., the method 200 learns as it processes additional data and minimizes the hamming distance. The reconfigurator 208 doesn't only update the exemplars, it also feeds back information, along path 210, to update the neural network layers used for feature extraction within the feature adaptor 206. The output at 212 may include identification of the matched features that are bundled to form identified objects and the confidence level of the object.

In an exemplary embodiment, information may be shared amongst edge devices as represented by path 214. Such information facilitates federated learning, where edge devices share, for example, features, descriptors, weights, exemplars and any other information useful in training and operation of the edge devices. For example, an edge device (first edge device) may be trained to recognize street signs but encounters a sign that it initially does not recognize. As the first edge device learns, it will create a new exemplar for the new street sign. Other edge devices may have yet to encounter the new street sign. The first edge device may communicate the new exemplar and any other necessary information to the other edge devices to provide the ability to recognize the new street sign. The communications to edge devices may be selected based on the type of edge device, may be to all edge devices, may be to individual edge devices, or any combination thereof.

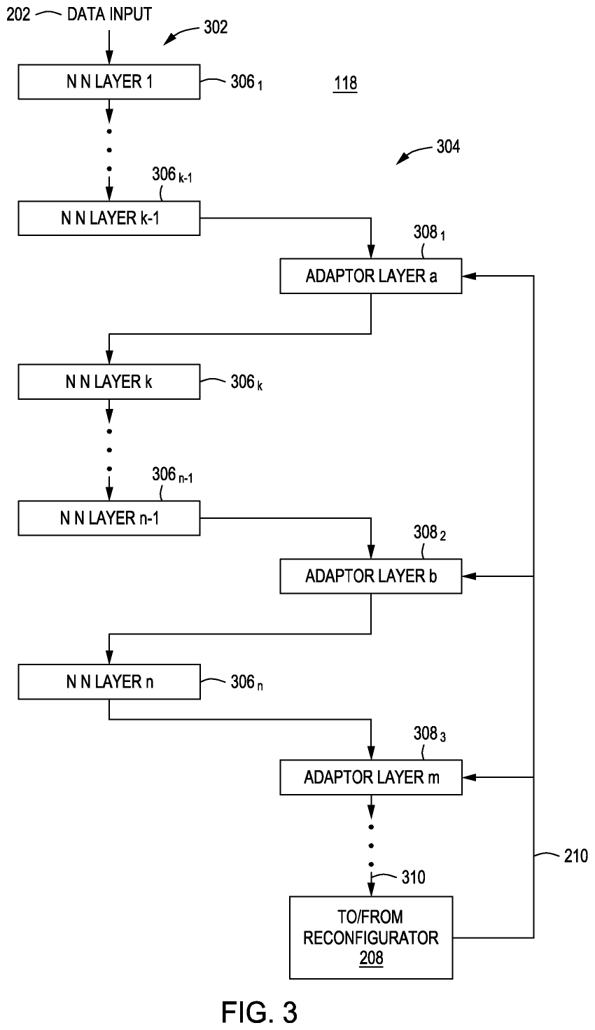

FIG. 3 depicts a block diagram of the first neural network 118 in accordance with at least one embodiment of the invention. The first neural network 118 comprises encoder layers 302 and adaptor layers 304. Although the adaptor layers 304 are depicted as being interspersed with the encoder layers, the adaptor layers 304 may be placed at the bottom of the encoder layers 302. The encoder layers 302 comprise a plurality of layers of weighted nodes (e.g., NN layer 1 at 306₁, NN layer k−1 at 306ₖ₋₁, NN layer n−1 at 306ₙ₋₁, NN layer n at 306ₙ). These layers are pretrained to identify and extract primary and semantic features from the input data 202. These layers are pretrained and are preloaded into the edge device. The encoder layers 302 are also swappable amongst edge devices.

In some embodiments, the first neural network 118 of the feature extractor and the second neural network 120 of the reconfigurator are combined into a single neural network. The single neural network may have layers of the feature extractor (encoder layers and adaptor layers) combined with reconfigurator layers. As such, the first neural network 118 may represent the functions of the feature extractor and the second neural network may represent the functions of the reconfigurator although the layers together form a single neural network. In operation, the reconfigurator adapts the first neural network, second neural network or both by performing at least one of: (1) altering weights, (2) adding layers, (3) deleting layers, (4) reordering layers to improve classification of extracted features to facilitate learning as described herein.

The adaptor layers 304 comprises a sparse plurality of layers of adaptable weighted nodes (e.g., adaptor layer a at 3081, adaptor layer b at 3082 and adaptor layer m at 3083). In the depicted embodiment, the adaptor layers 302 are interspersed with the encoder layers 304; however, in other embodiments, the adaptor layers 304 may all be located at the bottom of the stack of encoder layers 302. The adaptor layers 304 are designed to be adapted to a new environment and effectively adjust the operation of the feature extractor 203 of FIG. 1. The adaptor layers 304 comprises only a few percent of the size of the neural network 118. As such, only a limited amount of resources are necessary for online training of the neural network 300, i.e., adjusting the adaptor layers 304 while the edge device is operating in the field.

The output 310 of the first neural network 118 is coupled to the reconfigurator 208. Adaptor layer control signals from the reconfigurator 208 are coupled to the adaptor layers 304 via path 210. As the first neural network 118 operates to extract features based on the pretrained layers 302, the environment proximate the edge device may change. Such changes include day turns to night or vice versa, sensor modalities change, sensor perspective or resolution changes, etc. The reconfigurator 208, in addition to updating the class exemplars in the second neural network 120 in FIG. 1, identifies that a change has occurred and alters the weights of the adaptor layers 304 to compensate for the change or changes. Consequently, the feature extractor is adapted by the reconfigurator to the environmental change or changes to extract different or additional features from the data.

In a further embodiment, the reconfigurator 208 may be required to classify a new object, i.e., add a new class. The features of the object may be included in the encoder layers 302, but not in the necessary form to enable the reconfigurator 208 to classify the object. As such, the reconfigurator 208 updates its exemplars for the new class and adjusts the adaptor layers to enable the features to be properly identified such that the reconfigurator may classify the object when the object is present in the input date. In one embodiment, the reconfigurator 208 comprises a second neural network 120 in FIG. 1 that forms a flexible compute-efficient classifier using HD computing, where old classes are reconfigurable and new classes may be added without iterative learning, i.e., gradient-free learning. Class exemplars, which are centroids of each class in HD representations, are regarded as weights of the reconfigurator network layers that can be updated with HD operations.

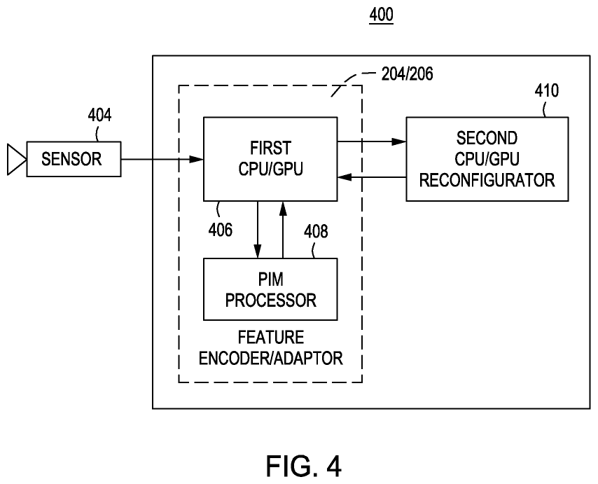

FIG. 4 depicts a block diagram of an exemplary hardware arrangement 400 in accordance with at least one embodiment of the invention. The hardware arrangement 400 (an exemplary embodiment of an edge device 102 in FIG. 1) comprises a processor arrangement 402 (an exemplary embodiment of processor(s) 108 in FIG. 1) and a sensor 404 for providing input data to the processor arrangement 402. The sensor 404 may be any form of device for gathering information about the environment proximate to the edge device. Exemplary sensors include imaging devices (e.g., cameras, LIDAR devices, RADAR devices, etc.), thermometers, radiation sensors, pollution sensors, chemical sensors, or combinations thereof, and the like. Generally speaking, the sensor may be any form of device that generates data containing information that can be extracted and classified.

The processor arrangement 402 comprises a first CPU/GPU 406, a PIM processor 408, and a second CPU/GPU 410. CPU/GPU means the processor can either be a CPU or a GPU. Exemplary CPU/GPUs that may be used include, but are not limited to, Samsung Exynos NPU, Qualcomm Snapdragon NPU, Intel Loihi, IBM TrueNorth and the like. Exemplary PIM processors include, but are not limited to, Gyrfalcon Lightspeeur, Mythic AI Accelerator, and the like. The first CPU/GPU 406 is coupled to the sensor 404 and to the PIM processor 408. Operating together, the CPU/GPU 406 and the PIM processor 408 perform the functions of the feature extractor 203 as described above and in more detail below. The second CPU/GPU 410 performs the functions of the reconfigurator 208 as described above and in more detail below.

By using a PIM processor 408, data storage and processing are co-located and intertwined. As such, a PIM processor reduces data movement and improves processing latency. HD computing uses bitwise vector operations that are well suited to PIM processors.

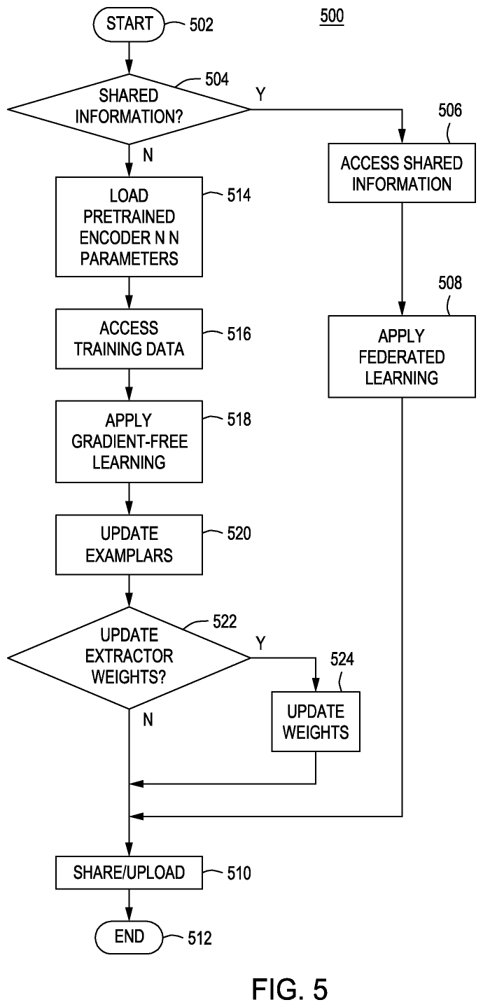

FIG. 5 depicts a flow diagram of an exemplary training process 500 for an edge device in accordance with at least one embodiment of the invention. The training process 500 may be performed before deployment of an edge device or during deployment of an edge device (i.e., online learning). In some embodiments, one edge device may be trained and subsequently, the neural network parameters of the trained edge device may be copied or otherwise loaded into and untrained edge device.

The process 500 begins at 502 and proceeds to 504 where the process 500 queries whether shared information is to be used for the training process. If the query is affirmatively answered, the process 500 continues to 506 where shared information is accessed. At 508, the process applies federated learning where the shared information is applied to the first and second neural networks to establish the network feature parameters (i.e., node weights and biases). In this manner, training of an edge device is accomplished by applying the feature parameters of previously trained neural networks to the networks of another edge device. Once the parameters are loaded, at 510, the newly stored parameters may be shared with other edge devices or uploaded to a central storage location for sharing at another time. The process 500 ends at 512.

If the query at 504 is negatively answered, the edge device will be trained using training data. At 514, the process 500 loads pretrained encoder neural network layer feature parameters into the feature extractor neural network. This step may include establishing initial feature parameters for the nodes in the adaptor layers as well. At 516, the process 500 accesses the training data for the edge device. This training data is used to train the reconfigurator neural network (second neural network) as well as update the weights in the adaptor layers, as needed.

At 518, the process 500 uses gradient-free learning to train the reconfigurator. A typical neural network is trained using a gradient descent-based technique where information is backpropagated within the neural network to update and optimize network parameters. Gradient descent-based learning is time consuming. The process 500 uses gradient-free learning such that no back propagation is necessary and the network learns very quickly. Researchers have studied three categories of gradient-free learning methods, including bio-inspired methods such as particle swarm optimization, genetic algorithms, simulated annealing. In other embodiments, target propagation (TP) and Hyperdimensional (HD) computing are both biological solutions for deep AI models. In other embodiments, the method may be an ADMM (Alternating Direction Method of Multipliers) based method and/or its variations (dlADMM, pdlADMM, ADMMiRNN). ADMMs decompose the network training into a sequence of sub-steps that can be solved as a simple linear least-squares problem. ADMMs can efficiently utilize available hardware resources and reduce computing time. Further embodiments may use kernel/range and extreme learning machines (ELM). Research models such as KARnet, ANnet, KPNet, ZORB, show 10-100× time reduction in shallow network models compared to the gradient-descent models. In some embodiments, various methods mentioned above may be combined to create a gradient-free learning method.

At 520, as training proceeds, the process 500 updates the exemplars used by the reconfigurator to classify and cluster extracted features. In an embodiment using HD computing, the exemplars are HD vectors and the network learns by optimizing the hamming distance between the exemplar vectors and the training data vectors. At 522, the process the process queries whether the feature extractor weights require updating. Generally, updates to the adaptor layers would not be necessary during initial training since the encoder layers would be pretrained to fit the training data. However, in some instances, the training data may contain environmental variations that will require the adaptor layers to be updated. As such, if the query at 522 is affirmatively answered, the process 500 proceeds to 524 where the process 500 updates the feature extractor weights in the adaptor layers. As such, the HD vectors produced by the extractor for a particular feature are altered to better match the exemplars. If the query at 522 is negatively answered, the process 500 proceeds to 510 where the parameters of the reconfigurator and/or adaptor may be shared with other edge devices or uploaded to a central storage for use by other edge devices at a later time. The process 500, ends at 512.

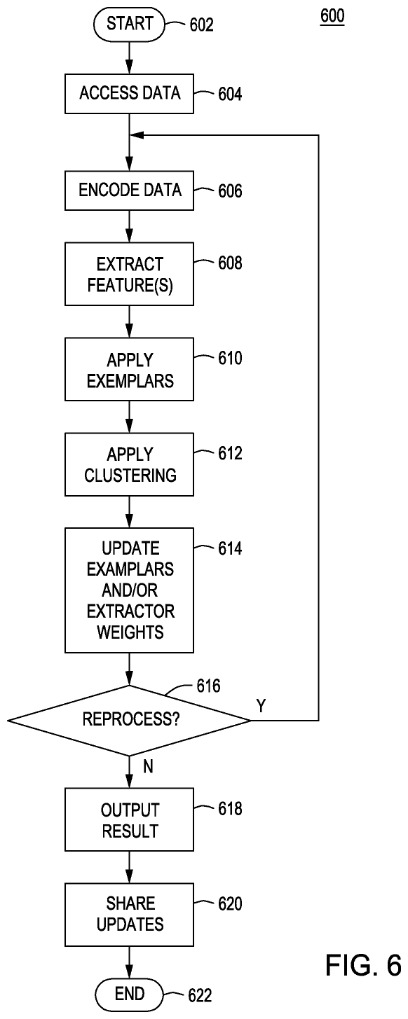

FIG. 6 depicts a flow diagram of an exemplary operation process 600 for an edge device in accordance with at least one embodiment of the invention. Once trained, an edge device uses the process 600 detect and classify features/objects contained in the input data. The process 600 begins at 602 and proceeds to 604 where the process 600 accesses input data (e.g., a stream of information from one or more sensors). At 606, the input data is encoded. In one embodiment, the data is encoded into HD vectors. The feature extractor performs both encoding and feature extraction functions. At 608, the process 600 extracts the features from the input data. As the first neural network is applied to the data, the data is transformed from, for example, images, to a set of HD vectors that match the criteria of the feature extractor. These HD vectors represent potential subject matter of interest within the input data (e.g., objects within image data).

At 610, the process 600 applies the exemplars of the reconfigurator to the extracted features and, at 612, applies clustering of the extracted features. The difference in match is measured between the extracted features and the exemplars. In one embodiment, the difference is measured as a hamming distance. A confidence level regarding the accuracy of the match is generated from the hamming distance. At 614, the process updates the exemplars and/or the weights of the feature adaptor to facilitate online learning and improve the accuracy of feature recognition. Updates are performed in an iterative manner that reduces the hamming distance.

At 616, the process 600 queries whether the input data should be reprocessed in view of the updates to the exemplars and adaptor weights. If the query is affirmatively answered, the process 600 proceeds to 606 to process the data again such that the first and second neural networks are iteratively updated until the hamming distance is optimized. If the query at 616 is negatively answered, the process 600 proceeds to 618 where the process 600 outputs the results (e.g., outputs a detected and classified object as well as a confidence level).

At 620, the updates to the exemplars and weights may be shared directly with other edge devices or uploaded to a central storage for subsequent use by other edge devices. The process 600 ends at 622.

### Example 1—No Adaptor Weight Update Needed

In a first exemplary embodiment, an edge device as described above may be design for recognizing particular types of vehicles (e.g., sedan, truck, van, etc.). The feature extractor is pre-trained with all car models and can extract any car from a data input (e.g., video or still photographs). In one embodiment, a car is encoded as a unique HD vector that captures the shape of the particular model of car. The reconfigurator applies exemplars to the extracted feature (e.g., car vector) to identify the type of car. For example, the feature is compared to a sedan exemplar, a truck exemplar, a van exemplar and so on. The exemplar having the best match (e.g., high confidence level represented, for example, by a small hamming distance) becomes the resulting output. As the identification process is performed, the exemplars may be updated to learn from the input data. In this example, the adaptor layer does not have to be updated because all of the possible extractable features were pre-trained, e.g., all possible car models.

### Example 2—Adaptor Weights and Exemplars Updated for Environment Change

In a second exemplary embodiment, an edge device is trained with video data of a scene taken from a specific viewpoint and is intended to identify a person in the input data performing specific activities (e.g., digging, walking, running, playing volleyball, etc.). The edge device is then used with a camera having a different viewpoint of the scene, i.e., a new environment is experienced. As such, the feature extractor and the reconfigurator will need to learn from the new experience, i.e., end-to-end training. In this instance, the reconfigurator exemplars are updated to adapt to the new viewpoint and the reconfigurator adjusts the adaptor layer weights to enable the feature extractor to optimally extract the people features from the data comprising the new viewpoint.

### Example 3—Adaptor Weights and Exemplars Updated for Classification Change

In a third exemplary embodiment, an edge device is trained with images of street signs (e.g., yield, stop, no entry, no bicycles, pedestrian crossing, etc.). The edge device is then asked to classify a new sign, e.g., the edge device is given a new class for a no parking sign. As such, the feature extractor and the reconfigurator will need to learn the new sign, i.e., end-to-end training. In this instance, the reconfigurator exemplars are updated to adapt to the new classification and the reconfigurator adjusts the adaptor layer weights to enable the feature extractor to optimally extract the new sign from new input images.

The methods and processes described herein may be implemented in software, hardware, or a combination thereof, in different embodiments. In addition, the order of methods can be changed, and various elements can be added, reordered, combined, omitted or otherwise modified. All examples described herein are presented in a non-limiting manner. Various modifications and changes can be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances can be provided for components described herein as a single instance. Boundaries between various components, operations and data stores are somewhat arbitrary, and particular operations are illustrated in the context of specific illustrative configurations. Other allocations of functionality are envisioned and can fall within the scope of claims that follow. Structures and functionality presented as discrete components in the example configurations can be implemented as a combined structure or component. These and other variations, modifications, additions, and improvements can fall within the scope of embodiments as defined in the claims that follow.

In the foregoing description, numerous specific details, examples, and scenarios are set forth in order to provide a more thorough understanding of the present disclosure. It will be appreciated, however, that embodiments of the disclosure can be practiced without such specific details. Further, such examples and scenarios are provided for illustration, and are not intended to limit the disclosure in any way. Those of ordinary skill in the art, with the included descriptions, should be able to implement appropriate functionality without undue experimentation.

References in the specification to “an embodiment,” etc., indicate that the embodiment described can include a particular feature, structure, or characteristic, but every embodiment may not necessarily include the particular feature, structure, or characteristic. Such phrases are not necessarily referring to the same embodiment. Further, when a particular feature, structure, or characteristic is described in connection with an embodiment, it is believed to be within the knowledge of one skilled in the art to affect such feature, structure, or characteristic in connection with other embodiments whether or not explicitly indicated.

Embodiments in accordance with the disclosure can be implemented in hardware, firmware, software, or any combination thereof. When provided as software, embodiments of the present principles can reside in at least one of a computing device, such as in a local user environment, a computing device in an Internet environment and a computing device in a cloud environment. Embodiments can also be implemented as instructions stored using one or more machine-readable media, which may be read and executed by one or more processors. A machine-readable medium can include any mechanism for storing or transmitting information in a form readable by a machine (e.g., a computing device or a “virtual machine” running on one or more computing devices). For example, a machine-readable medium can include any suitable form of volatile or non-volatile memory.

Modules, data structures, and the like defined herein are defined as such for ease of discussion and are not intended to imply that any specific implementation details are required. For example, any of the described modules and/or data structures can be combined or divided into sub-modules, sub-processes or other units of computer code or data as can be required by a particular design or implementation.

In the drawings, specific arrangements or orderings of schematic elements can be shown for ease of description. However, the specific ordering or arrangement of such elements is not meant to imply that a particular order or sequence of processing, or separation of processes, is required in all embodiments. In general, schematic elements used to represent instruction blocks or modules can be implemented using any suitable form of machine-readable instruction, and each such instruction can be implemented using any suitable programming language, library, application-programming interface (API), and/or other software development tools or frameworks. Similarly, schematic elements used to represent data or information can be implemented using any suitable electronic arrangement or data structure. Further, some connections, relationships or associations between elements can be simplified or not shown in the drawings so as not to obscure the disclosure.

This disclosure is to be considered as exemplary and not restrictive in character, and all changes and modifications that come within the guidelines of the disclosure are desired to be protected.

1. An edge device comprising:
a feature extractor comprising a first neural network for encoding input information into data vectors and extracting particular data vectors representing features within the input information, wherein the first neural network comprises at least one encoder layer and at least one adaptor layer;
a reconfigurator, coupled to the feature extractor, comprising a second neural network for classifying the particular data vectors and wherein, upon requiring additional features to be extracted, the reconfigurator adapts at least one layer in the first neural network, second neural network or both by performing at least one of: (1) altering weights, (2) adding layers, (3) deleting layers, (4) reordering layers to improve classification of particular data vectors; and
wherein the first neural network, the second neural network or both are trained using gradient-free training.

2. The edge device of claim 1, wherein the feature extractor extracts the particular data vectors using feature parameters defined by the first neural network and the classifier classifies the particular data vectors using classification exemplars defined within the second neural network.

3. The edge device of claim 2 wherein the feature parameters are pre-defined parameters, learned parameters, or a combination of predefined parameters and learned parameters and classification exemplars are pre-defined exemplars, learned exemplars, or a combination of predefined exemplars and learned exemplars.

4. The edge device of claim 1, wherein the feature extractor comprises a hyperdimensional encoder for generating hyperdimensional data vectors representing features within the input information.

5. The edge device of claim 1, wherein the first neural network, second neural network or both are capable of being retrained using gradient-free training.

6. The edge device of claim 1, wherein the edge device shares one or more exemplars or feature parameters with at least one other edge device to enable the first neural network, second neural network, or both of the other edge device to include the one or more shared exemplars or feature parameters.

7. The edge device of claim 6, wherein the exemplar or feature parameters sharing occurs to enable the other edge device to perform at least one of extracting or classifying a new feature.

8. The edge device of claim 1, wherein the first neural network is initially defined using a predefined model.

9. The edge device of claim 1, wherein at least one of the feature extractor or the reconfigurator are implemented using one or more process-in-memory circuits.

10. The edge device of claim 1, wherein the reconfigurator adjusts the second neural network to create additional exemplars based on changes in classification requirements.

11. The edge device of claim 1, wherein the reconfigurator alters the first neural network when an environment proximate the edge device changes.

12. A method of operating an edge device comprising:
training a first neural network, a second neural network, or both using gradient-free training;
encoding input information into data vectors and extracting particular data vectors representing features within the input information using the first neural network, where the first neural network comprises at least one encoder layer and an at least one adaptor layer;
classifying the particular data vectors using the second neural network; and
adapting, in response to a need for additional features to be extracted, at least one layer in the first neural network, second neural network or both by performing at least one of: (1) altering weights, (2) adding layers, (3) deleting layers, (4) reordering layers to improve classification of particular data vectors.

13. The method of claim 12, wherein extracting the particular data vectors further comprises using feature parameters defined by the first neural network and wherein classifying further comprises using classification exemplars defined within the second neural network.

14. The method of claim 13, wherein feature parameters are pre-defined parameters, learned parameters, or a combination of predefined parameters and learned parameters and classification exemplars are pre-defined exemplars, learned exemplars, or a combination of predefined exemplars and learned exemplars.

15. The method of claim 13, wherein encoding comprises performing hyperdimensional encoding to generate hyperdimensional data vectors representing features within the input information.

16. The method of claim 12, further comprising retraining the first neural network, second neural network or both using gradient-free training.

17. The method of claim 12, further comprising sharing one or more feature parameters or exemplars with at least one other edge device to enable the first neural network, the second neural network or both of the other edge device to include the shared feature parameters or exemplars.

18. The method of claim 17, wherein the feature parameter or exemplar sharing occurs to enable the other edge device to perform at least one of extracting or classifying a new feature.

19. The method of claim 12, further comprising initially defining the first neural network using a predefined model.

20. The method of claim 12, further comprising adjusting the second neural network to create additional exemplars based on changes in classification requirements.

21. The method of claim 12, further comprising altering the first neural network when an environment proximate the edge device changes.
